(19) United States
(12) Patent Application Publication
(10) Pub. No.: US 2020/0183039 A1
(43) Pub. Date: Jun. 11, 2020

(54) LINKED DIVING FAIRINGS AND METHOD FOR APPLYING A VERTICAL FORCE TO MARINE ELEMENTS

(71) Applicant: CGG SERVICES SAS, Massy Cedex (FR)

(72) Inventors: Kaare BRUROK, Øystese (NO); Svein DALE, Houston, TX (US); Timothee MOULINIER, Paris (FR)

(21) Appl. No.: 16/214,338

(22) Filed: Dec. 10, 2018

(51) Int. Cl. G01V 1/38

(52) U.S. Cl. CPC G01V 1/3817; G01V 2210/1423

(57) ABSTRACT

A diving fairing to be used with a front-end rigging in a seismic survey system, the diving fairing including a body extending along a longitudinal axis X; a first through passage formed along a transversal axis Y, which is perpendicular on the longitudinal axis X; and a second through passage formed along the transversal axis Y, offset from the first through passage.

### BACKGROUND

### Technical Field

Embodiments of the subject matter disclosed herein generally relate to a marine seismic survey system, and, more particularly, to a front-end rigging system that has linked diving fairings for directing downward one or more elements.

### Discussion of the Background

Marine seismic survey systems are used to explore the geophysical structure under the seafloor. This kind of exploration does not provide an accurate location for oil and gas reservoirs, but may suggest the presence or absence thereof to those trained in the field. Providing a high-resolution image of structures under the seafloor is an ongoing process.

Marine seismic surveys are usually conducted using a seismic vessel towing one or more seismic sources and a number of parallel streamers having detectors, such as hydrophones or geophones. In order to assemble the seismic data gathered by the detectors in a subsurface image, it is desirable to acquire and maintain a known geometry of the towed survey system (i.e., source, streamers, etc.), while seismic data is acquired. One of the devices employed to achieve and maintain the system's geometry is a deflector, which has an active portion towed underwater and is connected via ropes to other components of the survey system (e.g., the vessel, the source, the streamers, etc.).

For example, FIG. 1 shows a marine seismic survey system 100 that includes a vessel 110 towing plural streamers 120, each streamer carrying seismic detectors 122. The seismic detectors 122 are configured to record information related to seismic waves generated by a seismic source 130 and reflected from various structures of the subsurface. The streamers 120 are usually towed parallel at equal or known lateral distances from one another. In order to achieve and maintain this geometry, the streamers 120 are coupled to the vessel 110 via lead-ins 140.

FIG. 1 also shows that the marine seismic survey system 100 includes two deflectors 160, each coupled to the vessel 110 with a corresponding wide tow rope 180, and to a corresponding streamer 120 via a spur line 170. The heads 120A of the streamers 120 may have other ropes 124 in between (known as “spread ropes,” only one of these ropes is labeled) that are configured to maintain a constant separation between adjacent streamers. Depending on the angle made by the active portion of the deflectors 160 with the towing direction, lateral forces may occur, pulling apart the streamers 120, and thus maintaining the above noted separation distances. This angle may be adjusted, for example, by changing the deflector rigging (e.g., straps length) when the deflector is on the deck of the vessel. The wide tow ropes 180 and the deflectors 160 are usually connected to each other using a bridle block 150. The same bridle block 150 is used to also connected the deflector 160 to the most outer streamer 120, through the spur line 170.

A vertical cross-section of this arrangement is shown in FIG. 2. The deflector 160 is shown having a buoy part 161, which floats at the water surface 200, and a foil part 162, which is located underwater. The water flow acts on the foil part and generates the separation force while the buoy part maintains the deflector in a floating state. The bridle block 150 is attached to the foil part 162 with various ropes 164. The spur line 170 connects the head 120A of the streamer 120 to the bridle block. Note that the head of each streamer 120 is also attached to a head float 121, through a corresponding head rope 123. The head float 121 is provided to maintain a constant depth H of the head of the streamer relative to the water surface 200.

In a practical situation, the streamers are desired to have a given depth H, for example, 12 m. However, the bridle block 150 has a depth H′, which varies from deflector to deflector. For example, a typical depth H′ is about 6 m. This means that the spur line 170 does not extend in a horizontal plan, but rather as illustrated in FIG. 2. This position of the spur line is detrimental to the streamers because the spur line 170 would pull the adjacent streamers' heads upward due to the force F exerted by the deflector. Because of this effect, the head 120A of the most outer streamer 120 is not at the desired depth H, but rather at a depth H1, which is smaller than the depth H and larger than the depth H′. The same happens for the next streamer 120′, whose head 120A′ is pulled upward to a depth H2, larger than H1, but still smaller than the desired depth H. This depth perturbation happens for a couple of the streamers disposed closest to the deflector.

This phenomena is damaging for a seismic survey because the desired depth of all the streamers is typically a constant that is established before the survey starts. When the depth of the streamers is detected to be smaller (depth indicators are located on the streamer and directly connected to the vessel; note that GPS and acoustics and communication equipment is installed on the buoy 121, which can also transmit this information to the vessel), the operator of the vessel needs to make speed adjustments to the vessel (usually slows down the vessel), for trying to maintain the depth of the streamers at an acceptable level. Indeed hydrodynamic forces are related to the speed through water so the balance between hydrodynamic forces from the deflector, drag of the streamers, lead-in cables and separation ropes, drag of the head-float and static forces, such as the weight of the lead-ins, is varying with speed. In this regard, FIG. 3 illustrates a real situation in which the desired depth of the streamer fronts (first seismic traces) is indicated by curve 300, the actual depth of a streamer front (first trace) is indicated by curve 302, and the speed of the vessel, which is adjusted to increase the depth of the streamer, is indicated by curve 304. It is noted that the reduction in the speed of the vessel increases the cost of the seismic survey as the vessel takes more time to perform the entire seismic survey.

Accordingly, it would be desirable to provide systems and methods that maintain the desired depths of the streamers during a seismic survey so that a speed of the towing vessel does not have to be changed.

### SUMMARY

According to an embodiment, there is a diving fairing to be used with a front-end rigging in a seismic survey system. The diving fairing includes a body extending along a longitudinal axis X; a first through passage formed along a transversal axis Y, which is perpendicular on the longitudinal axis X; and a second through passage formed along the transversal axis Y, offset from the first through passage.

According to another embodiment, there is a set of M diving fairings to be attached to a first line of a seismic survey system. The set of M diving fairings includes a sub-set of N diving fairings that are linked to each other by a second line so that the N diving fairings maintain substantially the same angle of attack when towed in water, where M is an integer and N is an integer between 2 and M.

According to yet another embodiment, there is a seismic survey system having a deflector, a streamer having seismic receivers for recording seismic waves, a first line that connects the deflector to the streamer, first and second diving fairings attached to the first line, and a second line to connect the first diving fairing to the second diving fairing, wherein the second line has a density different than water.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a marine survey system;

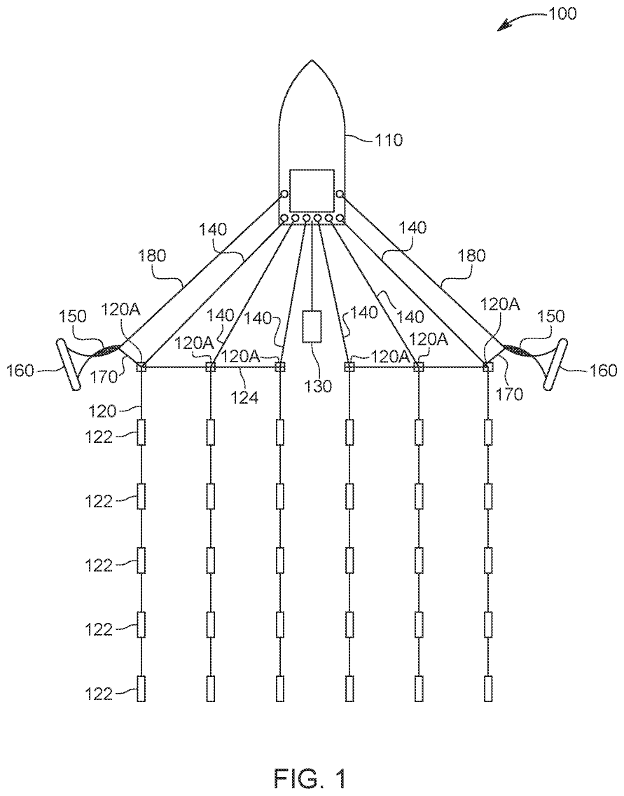

FIG. 2 illustrates how the depth of the streamers is affected by a deflector;

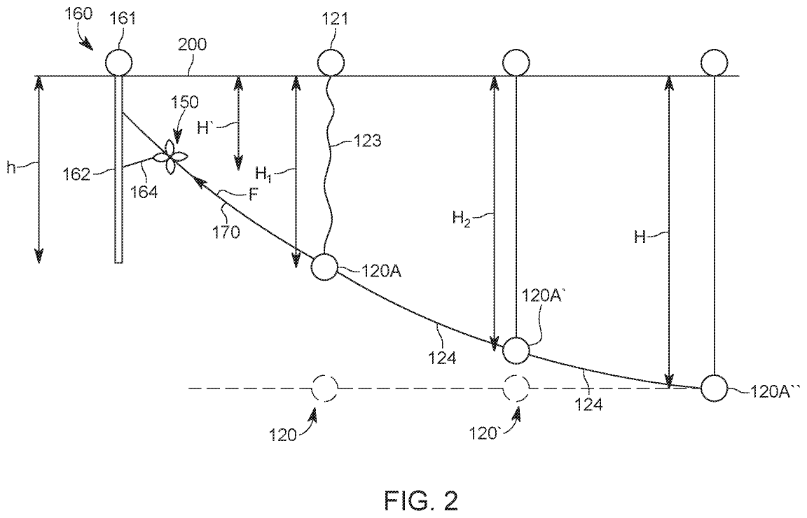

FIG. 3 illustrates how the speed of a towing vessel is changed in an effort to maintain constant the depth of the streamers;

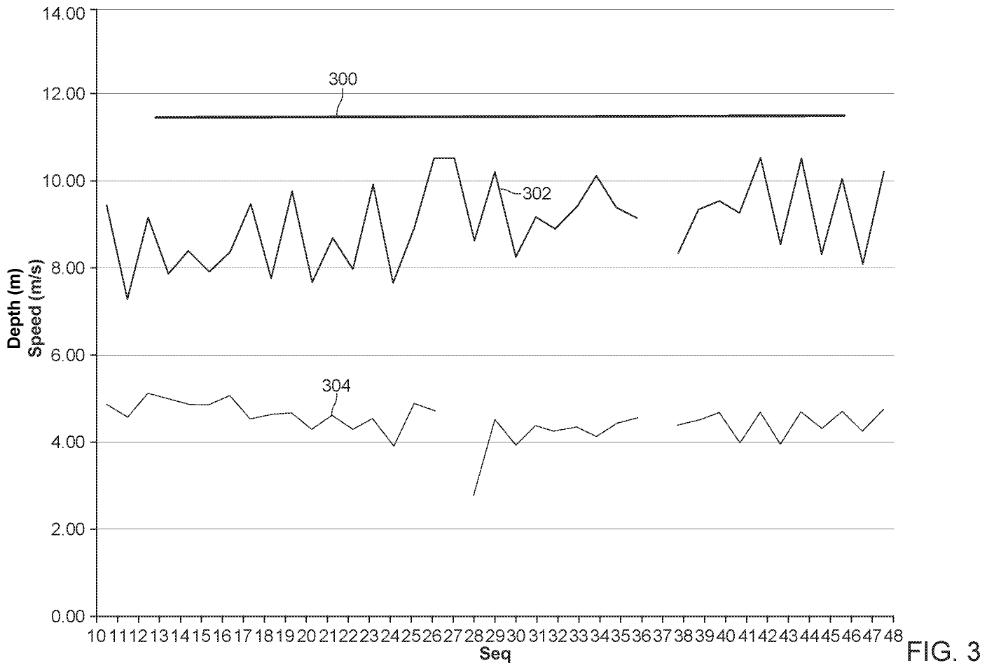

FIG. 4 illustrates a seismic survey system that uses deflectors for maintaining the streamers separated from each other and diving fairings for maintaining a depth of the streamers;

FIG. 5 illustrates the location of the diving fairings along a spur line or spread rope or both;

FIG. 6 illustrates a symmetrical anti-drag fairing;

FIG. 7A illustrates a symmetrical diving fairing and FIG. 7B illustrates the effect of static and dynamic forces that act on such a fairing at different speeds;

FIG. 8 illustrates an asymmetrical diving fairing;

FIG. 9 illustrates a diving fairing that is configured to have an addition through passage to be linked with an adjacent diving fairing;

FIG. 10 illustrates a construction of a linked diving fairing having two different passages;

FIG. 11 illustrates a front-end rigging having plural diving fairings linked to each other to maintain a similar angle of attack;

FIG. 12 illustrates the placement of the linked diving fairings and anti-drag fairings on the spur line and the spread rope of a front-end rigging system;

FIG. 13 illustrates the front-end rigging system having linked diving fairings only on the spur line and not on the spread rope;

FIG. 14 illustrates the front-end rigging system having linked diving fairings on the spur line and two spread ropes; and

FIG. 15 is a flowchart of a method for towing streamers with linked diving fairings.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a deflector having a bridle block located at a depth that is different from a desired depth of the streamers. However, the embodiments to be discussed next are not limited to these structures, but may be applied to other structures that have ropes that need to be moved in an upward or downward direction.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, one or more diving fairings are placed on the spur line and one or more of the spread ropes of a front-end rigging system. The diving fairings are designed to dive when towed in water, so that the diving fairing will force the spur line and/or the spread ropes to move downward or upward, so that the streamers are kept at a different depth than if the system would have no diving fairings. Note that the term “dive” and “diving” is used in this application to mean that the fairing is changing its depth when towed in water, either upward or downward. In one application, the diving fairing is asymmetrical and its geometry is selected to generate a vertical force while being towed through the water. In another application, the diving fairing is symmetrical, but its mass its distributed to have a changing density that creates both a static diving force and a bias that gives an angle of attack to the fairing and creates a hydrodynamic force in the vertical direction. Depending on the geometry of the fairing and/or the mass density distribution along the body of the fairing, the static and hydrodynamic forces may be aligned with the gravity or it may be opposite to the gravity. In another embodiment, it is possible to mix these two embodiments and build an asymmetrical fairing with a non-homogeneous density that will force the fairing to have an angle of attack and create a vertical force (upward or downward). In still another application, drag reducing fairings are mixed with the diving fairings and a density of such anti-drag fairings varies along the spur line and/or the spread ropes to achieve a diving effect on the streamers. In still another embodiment, two or more diving fairings are linked to each other so that they are not individually free to rotate and that their angle of attack is substantially constant. These diving fairings may be linked with another rope. All these embodiments are now discussed in more detail with regard to the figures.

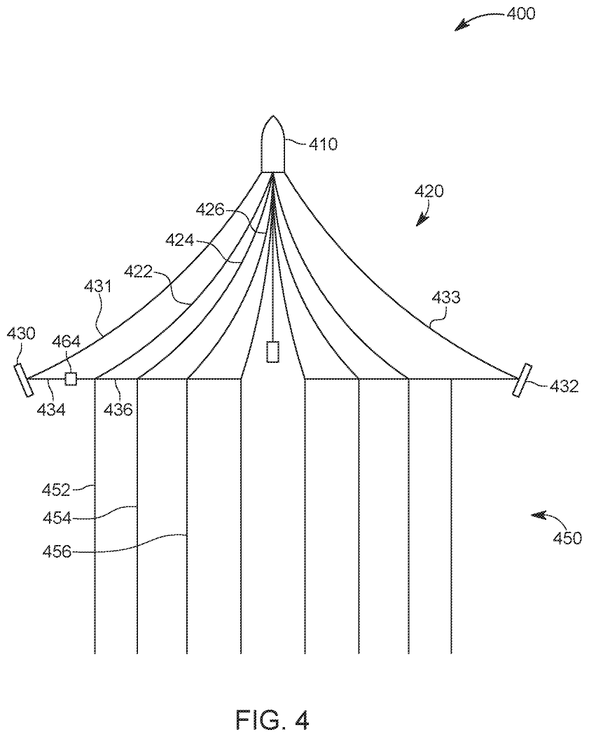

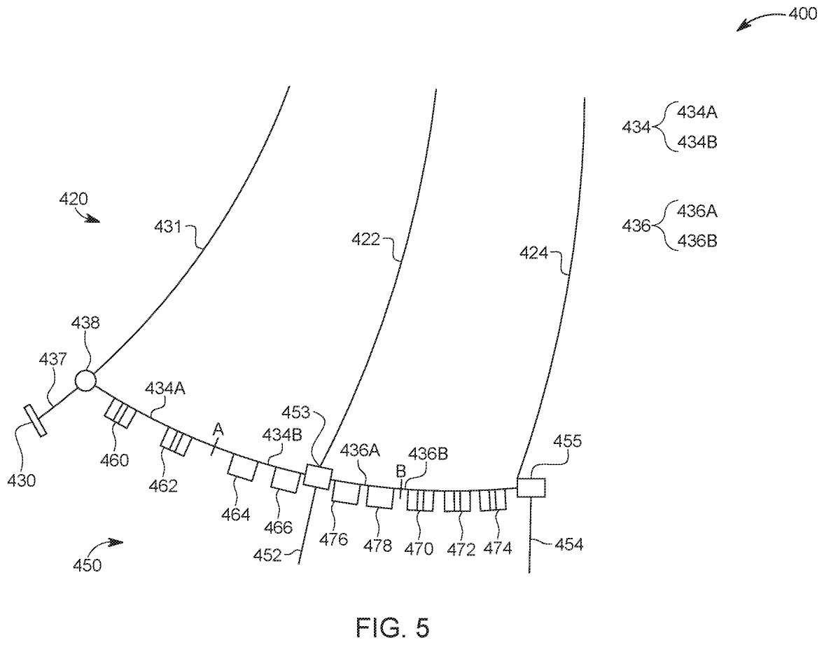

FIG. 4 shows a seismic survey system 400 that includes a vessel 410 that tows a streamer spread 450. The streamer spread 450 is attached to the vessel 410 through a front-end rigging system 420. The streamer spread 450 includes plural streamers 452, 454, 456 (only three streamers are labeled for simplicity). The streamer spread can have up to 20 or 30 streamers. Each streamer is connected to the front-end rigging system 420 with a corresponding lead-in 422, 424, and 426. The front-end rigging system 420 includes two deflectors 430 and 432, one on each side of the streamer spread, for pulling away the streamers from each other. Each deflector is connected to the vessel 410 with a corresponding wide tow rope 431 and 433, and to the most outer streamers with a corresponding spur line 434. A diving fairing 464 is schematically illustrated as being attached to the spur line 434. Each pair of adjacent streamers (e.g., 452 and 454) is connected to each other, at their head parts, with a spread rope 436. For a better understanding of the invention, a small part of the front-end rigging system 420 and the streamer spread 450 is shown in FIG. 5. The deflector 430 is shown in the figure being connected with one or more ropes 437 to a bridle block 438.

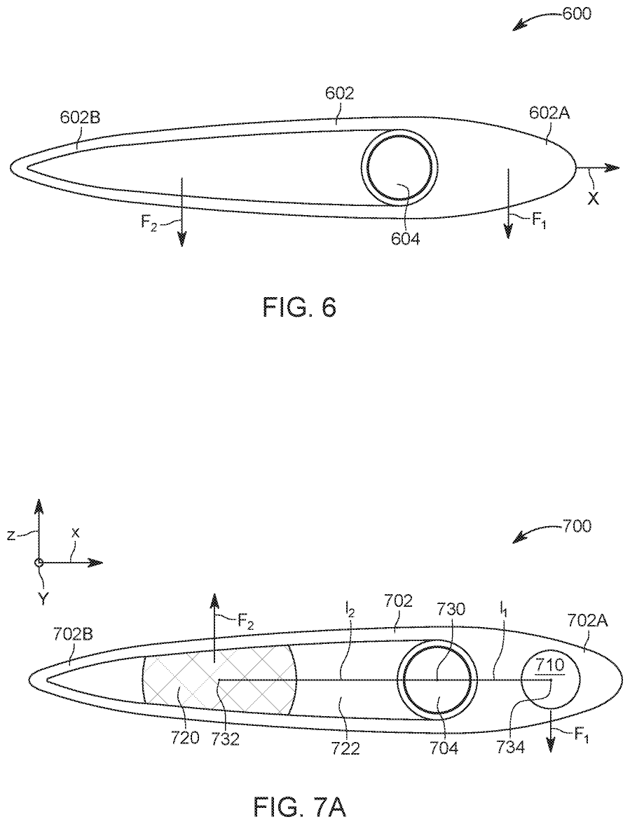

FIG. 5 shows plural anti-drag fairings 460 and 462 (only two are shown for simplicity, but more may be added) distributed along the spur line 434 and plural anti-drag fairings 470, 472, and 474 distributed along the spread rope 436. Such anti-drag fairings are located on the spur line and spread ropes to reduce a drag exerted by these elements when towed in water. FIG. 6 shows an anti-drag fairing 600 having a body 602 in which a single passage 604 is formed. The body 602 of the fairing is symmetrical relative to a longitudinal axis X. The anti-drag fairing 600 is attached to the front-end rigging system by placing the spur line 434 or the spread rope 436 through the passage 604. Such a symmetrical fairing is manufactured to have its weight distributed along its body so that, when in water and mounted on the spur line 434 or the spread rope 436, the anti-drag fairing is balanced, i.e., its front end 602A and its back end 602B remain in equilibrium relative to the passage 604, as illustrated by forces F1 and F2 in the figure. In other words, an angle of attack of the fairing is zero (i.e., the fairing is substantially horizontal). Typically, the fairings are manufactured with a neutrally buoyant material to make the forces F as close as possible to zero. Also, they are usually designed to be filled with water through large openings to ensure that they have very limited buoyancy difference with the water. For such balanced forces, the overall torque generated by the two forces F1 and F2 is zero.

This means that the traditional profile of the anti-drag fairing, which is attached to the front-end rigging system, is not designed to move its corresponding host (spur line or spread rope) up or down, but only to reduce a drag and vibration exerted by the movement of the cylinder rope in water. The fairings 460, 462, 470, 472, and 474 in FIG. 4 have exactly this role, i.e., they are balanced so that the drag in water of the host is reduced, but these fairings do not move the host upward or downward along gravity.

In addition, it is noted that a traditional anti-drag fairing has a single hole or passage 604 through the body 602, and this passage is designed to hold the rope to which the fairing is to be attached for reducing the drag.

However, according to the embodiment of FIG. 5, in addition to the anti-drag fairings, diving fairings are added to at least one of the spur line and the spread rope. FIG. 5 shows that diving fairings 464 and 466 are added to the spur line 434 and diving fairings 476 and 478 are added to the spread rope 436, closest to the spur line 434. The number of diving fairings can vary from the spur line to the next spread rope, or from one spread rope to another.

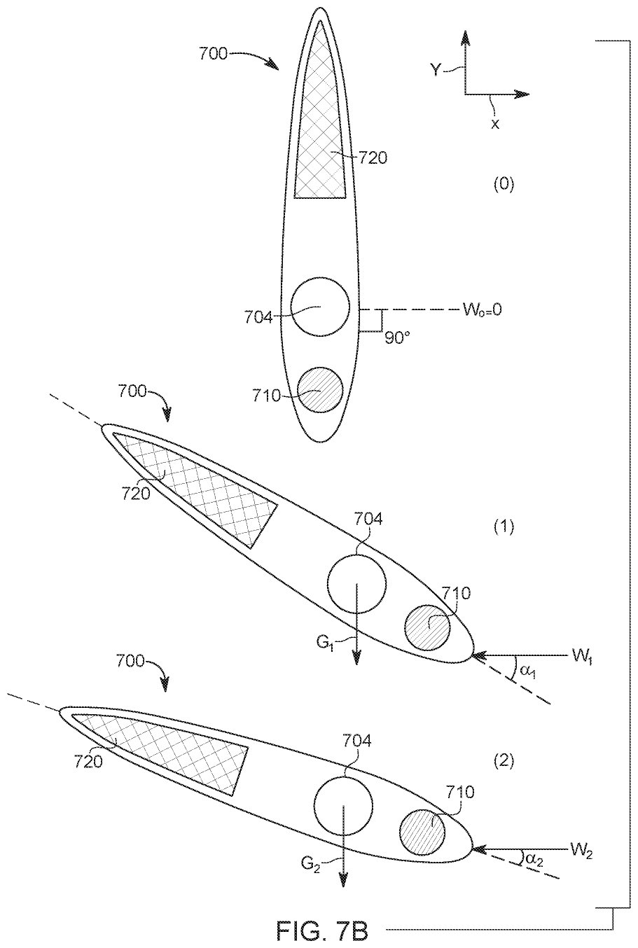

A diving fairing 700 is shown in FIG. 7A and has a body 702 and a single passage 704 formed in the body for accommodating a corresponding rope. The body 702 is symmetrical relative to a longitudinal axis X and the passage 704 is formed to extend along a transversal axis Y, which is perpendicular on the longitudinal axis X (i.e., axis Y enters into the page in FIG. 7A). A heavy weight 710 is distributed at the leading end 702A of the body while a light weight 720 is distributed at the trailing end 702B, inside the body 702. The heavy weight 710 may include steel, metal, lead, or any heavier than water material while the light weight 720 may include any material that is lighter than the water, e.g., air, foam, plastic or a light composite. The purpose of making the weight distribution of the body 702 uneven, heavy at the leading end 702A and lighter at the trailing end 702B is to create two (unequal) forces F1 and F2, that act in opposite directions as shown in FIG. 7A, so that a net torque is formed on the diving fairing when attached to a rope, and the net torque makes the leading end 702A to dive, thus, creating a non-zero angle of attack of the diving fairing, making the entire rope to dive. Note that the light weight 720 may occupy partially an internal chamber 722 formed inside the body 702, or the entire chamber. The internal chamber may be water tight. However, in one embodiment, water seeps or is intentionally allowed into the internal chamber, but the positive buoyancy of the internal chamber is maintained due to the light weight 720 including a material that is lighter than the water. In this regard, FIG. 7A illustrates the center of mass 732 of the light weight 720 and the center of mass 734 of the heavy weight 710 and the forces F1 and F2 generated by these weights. The locations of the light and heavy weights are selected in such a way that the torque generated by the heavy weight (length l1 times force F1) and the torque generated by the light weight (length l2 times force F2) combine to produce a positive net torque l₁F₁+l₂F₂>0 that tends to rotate the leading edge 702A to become deeper than the trailing edge 702B, when towed in water, which results in an angle of attack of the profile and the diving effect expected from the diving fairing. In this embodiment, the length l1 is shorter than the length l2.

The diving fairing 700, although looking the same from the outside as the anti-drag fairing 600, has this characteristic of diving when deployed and towed in water, due to the density variation along the longitudinal axis X. Note that an anti-drag fairing 600 may also have a varying density along the longitudinal axis X, but overall, the mass distribution of the anti-drag fairing is calculated to create minimal forces when in water (as close as possible to be neutrally buoyant) and the same torque at the trailing end and the leading end so that no net torque is exerted about the rope placed in the passage 604. This is not the case for the diving fairing, where the mass distribution is calculated on purpose to generate a net torque about the rope placed in the passage 704, so that the diving fairing is making an angle of attack that generates diving forces.

The angle of attack of a fairing is dependent upon the material, the volume, and the location of the light and heavy weights, but also upon the water speed. Indeed, forces F1 and F2 shown in FIG. 7A are static forces, but hydrodynamics forces are also applying to the diving fairing and they depend on the water speed. In this regard, FIG. 7B shows three modes (0) to (2) of the diving fairing 700. The reference mode (0) is when the longitudinal axis of the diving fairing is aligned with the gravity and the diving fairing is not moving in water, i.e., its speed relative to the water is zero. In this case, the hydrodynamic force W₀ is zero. Mode (1) shows a case when the diving fairing makes an angle of attack α₁ with the horizontal direction and the water resistance force W₁ is non zero. In this case, a force G₁ acts along the gravity on the diving fairing. Mode (2) shows a case when the diving fairing makes a smaller angle of attack α₂ with the horizontal direction, than the angle of attack for mode (1), and the water resistance force W₂ is now larger than W₁. In this case, the force G₂, which acts along the gravity on the diving fairing, has also changed its value.

The diving fairings are designed to reach a given equilibrium between the static forces and hydrodynamic forces, which meets the desired magnitude for the vertical force to be applied to the spread rigging and targeted geometry. Thus, a small asymmetry in the geometry or density or both of a fairing is sufficient to create a diving fairing. Also note that the diving fairing 700 is configured in this embodiment to not move upward along the Z direction, but only downwards. Nevertheless, the principles and features discussed in this embodiment can be applied to create an upward force by swapping the position of the light weight and heavy weight relative to the rope location, so that the diving fairing makes an angle of attack exerting an overall force (static+hydrodynamic forces) in an upward direction.

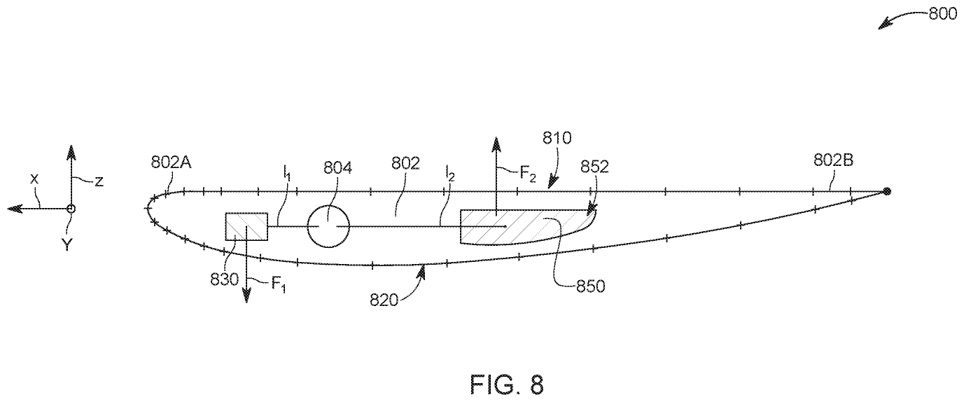

A diving fairing may also be implemented to have a non-symmetrical body as illustrated in FIG. 8. Diving fairing 800 has a non-symmetrical body 802 that includes a passage 804 through which a corresponding rope is pulled. The body 802 extends along a longitudinal axis X and the passage 804 extends along a transversal axis Y, which is perpendicular on the axis X. The diving fairing 800 has a top surface 810 and a bottom surface 820. The bottom surface 820 or top surface 810 or both the top and bottom surfaces are made to have a curvature that promotes a diving of the fairing due to the difference of hydrodynamic pressure while towed through water. For example, the top surface 810 may be flat (i.e., extends in a 2D plan) and the bottom surface 820 may be curved as shown in FIG. 8. In another embodiment, the top surface 810 has an area that is smaller than an area of the second surface 820, and the second surface is curved so that a hydrodynamic pressure is lower at the bottom surface than at the top surface and thus, the body exerts a diving force on the rope when towed in water. The asymmetrical profile creates a vertical force and the diving fairing is designed so that it reaches an equilibrium while towed through water and exert a stable downward or upward force on the rope. This equilibrium is varying with a geometry profile of the diving fairing and water speed. One skill in the art would know to design a profile to obtain hydrodynamic forces that meet the desired magnitude for the spread rigging and geometry targeted.

Alternatively, a weight 830 may be positioned inside the non-symmetrical body 802 to generate a torque around the passage 804 so that the leading edge 802A is diving when the fairing is towed in the water. In one application, a light weight 850 may be placed inside an internal chamber 852, toward the trailing end 802B, to generate an upward force F2, to further increase the torque applied on the fairing. In other words, this embodiment combines the effect of an asymmetrical geometry foil and an asymmetrical density foil. If both the weight 830 and the light weight 850 are placed inside the body 802, at distances l1 and l2, respectively, from the center of the passage 804, these two weights will generate forces F1 and F2, having the directions shown in the figure. The torques produced by the two weights add to each other to rotate the diving fairing to have the leading edge 802A deeper than the trailing edge 802B, when the fairing is towed in water, i.e., the fairing makes a non-zero angle of attack when towed in water. In one application, if water seeps into the internal chamber 852, the overall buoyancy of the internal chamber stays positive due to the weight 850 including a material lighter than the water.

Any fairing that is configured to dive when towed in water may be used for pulling down or up the spur line and/or the spread rope in a front-end rigging system. The diving fairings may be casted or extruded from plastic, composite or a similar material to the anti-drag fairings.

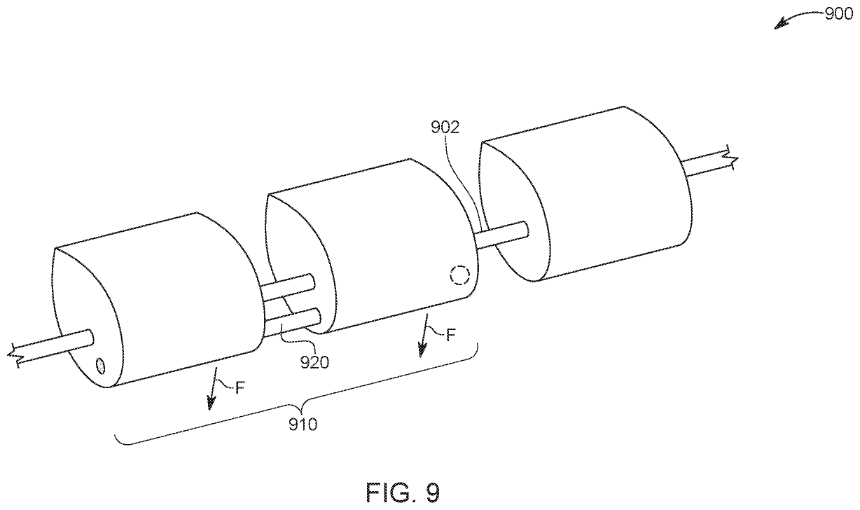

The inventors have observed that by using the diving fairings 700 or 800, it is possible that one or more of them would have an angle of attach while other diving fairings might have a different angle of attack. In other words, if plural diving fairings are distributed along the spur line and/or spread lines or any other line of the front-end rigging, it is possible that each diving fairing to have its own angle of attack, which sometimes is not desirable. Thus, according to an embodiment illustrated in FIG. 9, if there is a set 900 of diving fairings distributed along a line 902 (which may be a spur line 434 or a spread line 436 or any other line of the front-end rigging system), a subset 910 of the diving fairings may be connected (linked) to each other not only through the line 902, but by an additional rope 920. The number M of diving fairings in the set 900 of diving fairings may be from 1 to any integer number. The number N of the diving fairings in the subset 910 of diving fairings may be from 2 to any integer smaller or equal to number M. In one application, a sub-set of M-N diving fairings are linked to each other only by the line 902 so that the M-N diving fairings have independent angles of attack.

The additional rope/line 920 may be a heavy line, for example, having metal wires braided inside, so that a leading portion of the diving fairing is heavier than a trailing portion to make a non-zero angle of attack to generate a vertical net force F that would move the fairing down. In this embodiment, the additional line 920 acts as the heavy weight of the diving fairing shown in FIGS. 7A and 8. If the rope 920 is made of a light material, it is possible to generate an angle of attach that would create a vertical net force that would move the fairing up. Because the additional rope 920 connects the leading portion of two or more diving fairings to each other, their angle of attach are synchronized, i.e., all the N members of the subset 910 would likely have a substantially similar angle of attack (within 10 to 20% of the desired value).

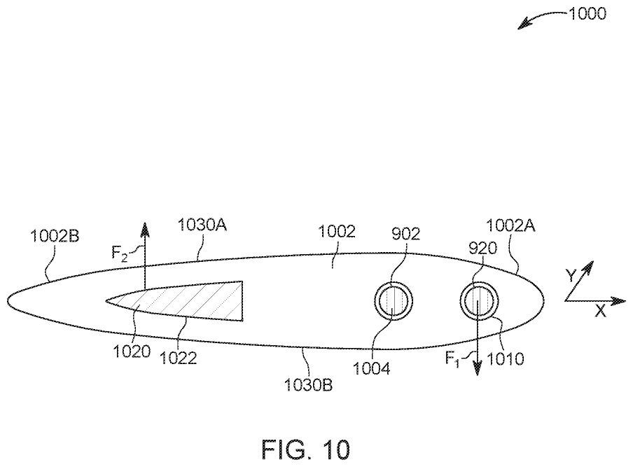

A diving fairing 1000 that is manufactured to receive not only the line 902, but also the additional line 920 is discussed with regard to FIG. 10. Diving fairing 1000 has a body 1002 that extends along a longitudinal axis X and includes not a single through passage 1004, but an additional passage 1010. The two passages 1004 and 1010 extend transversally through the body 1002, parallel to each other, along a transversal axis Y. The second passage 1010 is offset along the longitudinal axis X, from the first passage 1010. In one embodiment, axis Y is perpendicular to axis X. The first line 902 would be located inside the first through passage 1004 and the second line 920 would be located inside the second through passage 1010. As discussed above, the weight of the second line 920 is selected to make the leading portion 1002A of the body to dive down, i.e., make an angle of attack that moves the diving fairing 1000 in a downward direction, or to make an angle of attach that moves the diving fairing in an upward direction.

An additional weight (called herein light weight) 1020 may be placed in a corresponding chamber 1022, located at the trailing portion 1002B, to generate a positive buoyance, to further enhance the diving down effect of the rope 920 when this rope is selected to be heavy. Thus, the rope 920 generates in this embodiment a downward force F1 while the light weight 1020 generates an upward force F2. The two forces generate a net torque that make the angle of attach and achieve the diving down effect. Based on the embodiment illustrated in FIG. 10, one skilled in the art would understand that the additional/second through passage 1010 may be moved to be located in the trailing portion 1002B and the light weight 1022 may be located in the leading edge 1002A, for achieving an upward moving effect of the diving fairing. This means that the second through passage 1010 can be located between the first through passage 1004 and either tip of the body 1002.

Even if the net torque produced by forces F1 and F2 is substantially zero, it is possible to adjust a geometry of the faces 1030A and 1030B of the body 1002, similar to the embodiment discussed in FIG. 8, for achieving a non-zero angle of attack, either positive or negative. In this case, the second rope 920 is not used for influencing a value of the angle of attack, but only to link two or more diving fairings 1000 to each other to maintain a similar (or the same) angle of attack.

Returning to FIG. 5, the configuration of the front-end rigging system 420 includes a given number of diving fairings distributed along the spur line 434 and the same number of diving fairings distributed along the spread rope 436. Further, FIG. 5 shows that the spur line 434 is divided into two segments, a first segment 434A that extends between the bridle block 438 and point A and a second segment 434B that extends between point A and the head 453 of the first streamer 452 (or the outer most streamer). The spread rope 436 is also divided into two segments, a first segment 436A that extends from the head 453 of the first streamer 452 to point B and a second segment 436B that extends from point B to the head 455 of the second streamer 454 (or the second most outer streamer). In one application, the anti-drag fairings are located only on the first segment 434A of the spur line and the diving fairings are located only on the second segment 434B of the spur line. In this application, the first segment 434A may be 70% of the entire spur line with the second segment 434B being only 30%. In other words, a length of the first segment is larger than a length of the second segment. In this context, note that a total length of the spur line may be in the order of 100 m and the total length of a spread rope may be in the order of 25 to 200 m, depending on the type of survey.

In another application, the diving fairings are located only on the first segment 436A of the spread rope 436 while the anti-drag fairings are located only on the second segment 436B of the spread rope. The percentage of the first segment to the second segment for the spread rope may be 30 to 70%, i.e., a length of the first segment is smaller than a length of the second segment.

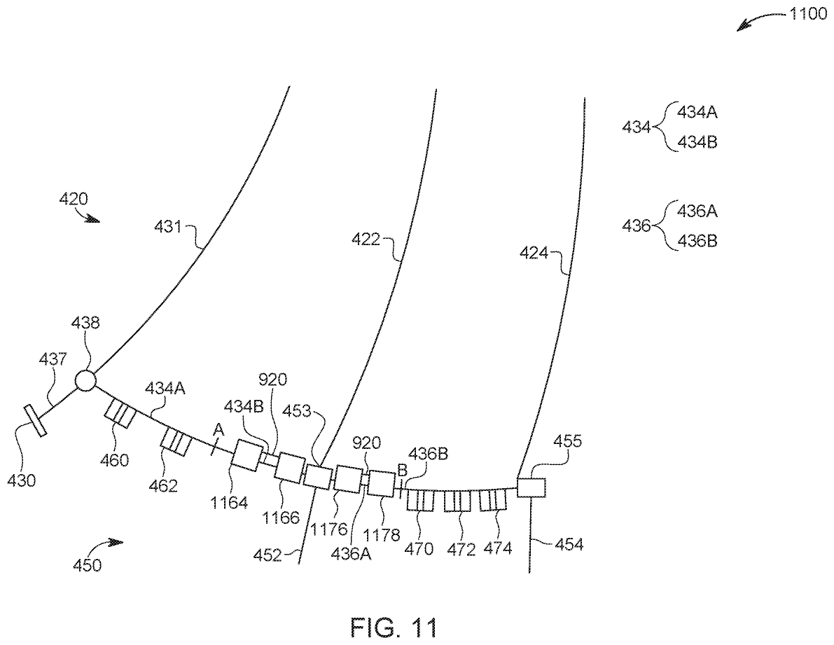

The same arrangements may be implemented if the linked diving fairings are used. For example, FIG. 11, which is similar to FIG. 5, shows diving fairings 1164 and 1166 connected with the second rope 920, in addition to the spur line 434 and diving fairings 1176 and 1178 also connected with a second rope 920, in addition to the spread rope 436.

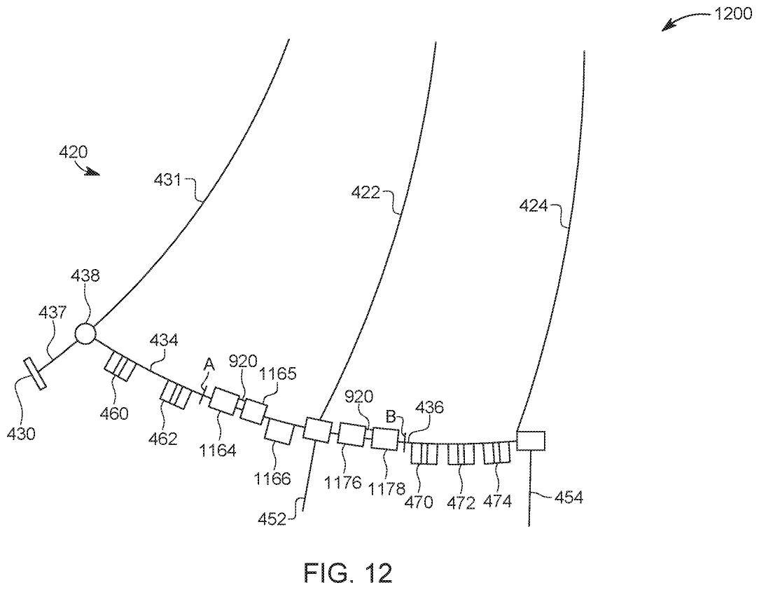

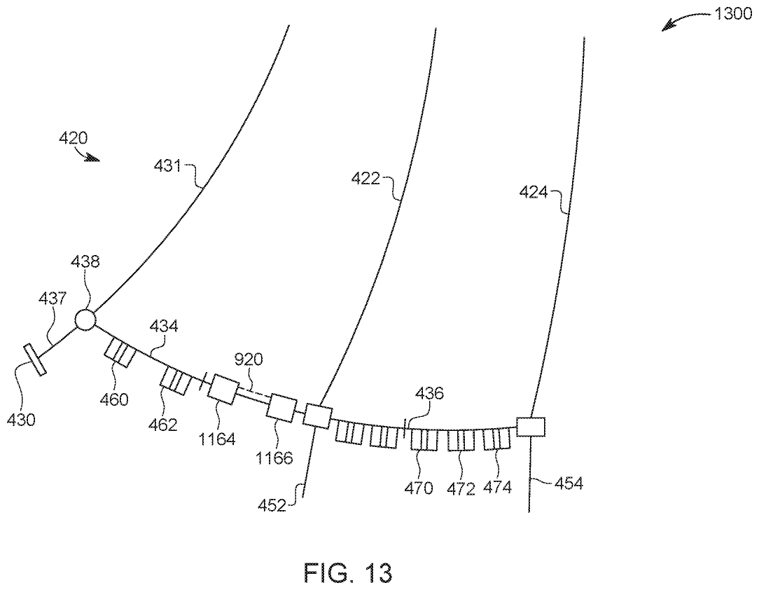

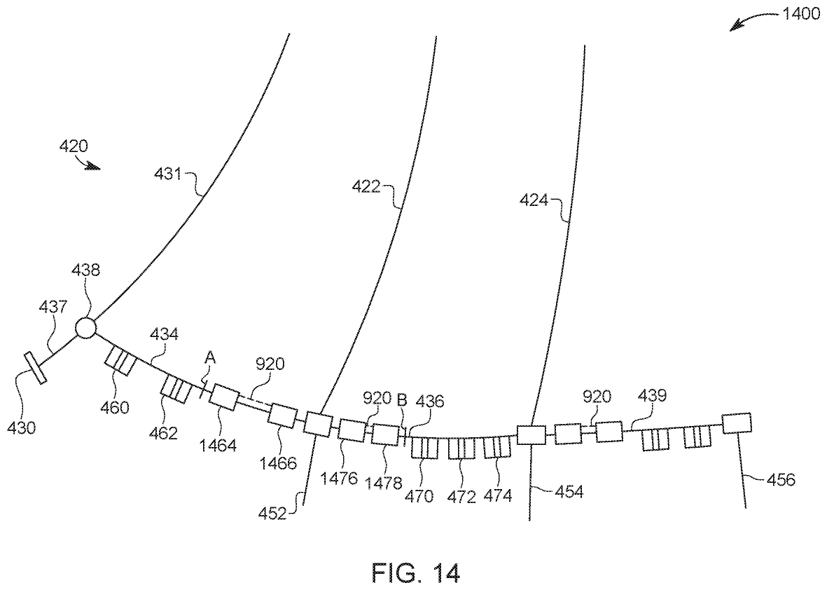

According to an embodiment illustrated in FIG. 12, the front-end rigging system 1200 has more diving fairings on the spur line than on the adjacent spread rope. Further, in this embodiment there are two linked diving fairings 1164 and 1165 and one free diving fairing 1166 on the spur line 434. The diving fairings 1176 and 1178 on the separation line 436 may be linked or free. In yet another embodiment, as illustrated in FIG. 13, the front-end rigging system 1300 has diving fairings attached only to the spur line and not to the spread rope. The diving fairings 1164 and 1166 could be free or linked to each other by rope 920. Rope 920 is shown with a dash line to indicate that it is optional. In still another embodiment, as illustrated in FIG. 14, the front-end rigging system 1400 has diving fairings and anti-drag fairings located on the next spread rope 439, which connects streamer 454 to the next streamer 456. Again, one or more subsets of the diving fairings may be linked to each other with a second rope 920. In one application, the diving fairings are not placed on each spread rope, only on the first, or the first and second, or the first to third spread ropes when counting from the spur line. These diving fairings may be connected or not with a second line to each other to maintain substantially the same angle of attack when towed under water. According to the embodiments illustrated in FIGS. 5 and 9-14, the diving fairings can be distributed only on the spur line, only on a spread rope, on both of them, or on the spur line and a limited number of spread ropes. Further, any two or more diving fairings, which are adjacent to each other, may be linked to each other with a second line/rope so that a desired angle of attack is achieved (when the weight of the second rope is selected accordingly) or maintained (when a stiffness of the second rope is high so that the sub-set of linked diving fairings acts as a single fairing). Furthermore, a density of the diving fairings on the spur line and/or the spread ropes can vary, with more diving fairings on the spur line than the spread rope, or more diving fairings on the spread rope than the spur line, or a same density on both lines. In addition, a number of diving fairings that are connected to each other may vary from the spur line to the separation line or the number may be the same.

An advantage of using diving fairings to keep down the heads of the streamers located next to the deflectors is the fact that no extra equipment is necessary for the existing seismic spread as some of the anti-drag fairings are being replaced with the diving fairings. If linked diving fairings are used, the existing diving fairings may be manufactured to have an extra through channel and a rope or line can be inserted through these through channels to link the fairings to each other at their leading edge.

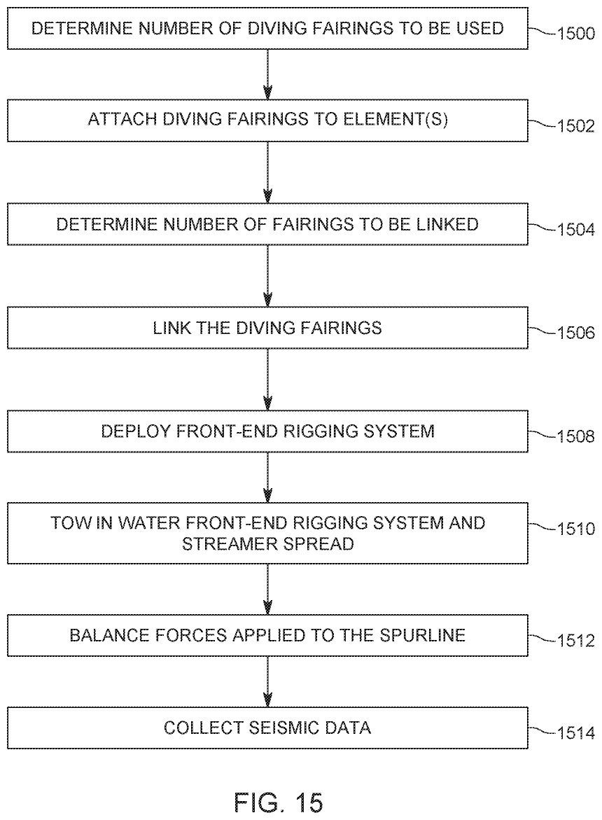

A method for maintaining (or lowering or raising) the heads of the streamers, located next to the deflectors of the front-end rigging system, is now discussed with regard to FIG. 15. According to this method, in step 1500, both the design and the number of diving fairings to be attached to an element of the front-end rigging system are determined. This number and the design of the fairings are determined based on the force magnitudes and distributions required to achieve the desired spread and the properties of the various elements such as the size of the deflector, the depth of the bridle block, the desired depth of the head of the streamer, and the downward force exerted by each diving fairing, the lead in weight, the streamer length, etc. Typically, simulation tools can be used to determine the number and design of the fairings to be used on the spread. For example, by calculating the depth difference between the bridle block and the streamer, and by knowing the size of the deflector, the upward force exerted by the deflector on the spur line can be calculated. This force is then divided to the individual forces generated by each diving fairing, to calculate the number of diving fairings to be used. If the number is so large that they do not fit on the spur line, a decision is made to split the number of necessary diving fairings and to attach a first set to the spur line and a second set to the adjacent spread rope or ropes. Similarly, the design of the diving fairing can be adjusted to create more vertical forces. The anti-drag fairings and diving fairings are attached in step 1502 to an element of the front-end rigging system. The element can include the spur line, the spread rope or both. In step 1504, the number of diving fairings that need to be linked is determined and in step 1506 those diving fairings are linked to each other with a second rope. In step 1508 the front-end rigging system is deployed in water and used to tow a streamer spread. In step 1510, the front-end rigging system and the streamer spread are towed in water by a vessel. In step 1512, an upward force exerted on the outer most streamer by a deflector of the front-end rigging system is contra-balanced by a downward force exerted by the linked diving fairings attached to the element. In step 1514, the vessel tows the front-end rigging system and the streamer spread and seismic data is collected by the seismic receivers distributed along the streamer spread.

The disclosed embodiments provide a diving fairing that corrects a depth of a streamer when pulled upward by a deflector and the diving fairing is configured to be linked with an adjacent diving fairing. With the same embodiments, one skill in the art can create an upward forces by adjusting asymmetrical geometry or asymmetrical density. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A diving fairing to be used with a front-end rigging in a seismic survey system, the diving fairing comprising:
a body extending along a longitudinal axis X;
a first through passage formed along a transversal axis Y, which is perpendicular on the longitudinal axis X; and
a second through passage formed along the transversal axis Y, offset from the first through passage.

2. The diving fairing of claim 1, wherein the body is symmetrical relative to the longitudinal axis X.

3. The diving fairing of claim 1, wherein a weight of the body is distributed asymmetrically along the X axis to generate a net torque about the first through passage that makes a leading edge to move deeper in water than a trailing edge to create a non-zero angle of attack of the body with a horizontal direction.

4. The diving fairing of claim 1, further comprising:
a weight rope/cable provided in one of the first or second passages, wherein the weight rope/cable has a different density than water and makes the diving fairing make a non-zero angle of attack.

5. The diving fairing of claim 1, further comprising:
a weight rope/cable provided in one of the first or second passages, wherein the weight rope/cable has a different density than water and makes the diving fairing in making a non-zero angle of attack; and
the weight rope/cable is connecting the diving fairing to another diving fairing.

6. The diving fairing of claim 1, further comprising:
a weight located adjacent to the trailing edge of the body, wherein the weight has a positive buoyancy in water.

7. The diving fairing of claim 1, wherein one of the first or second through passage is configured to receive an element of a front-end rigging system that connects the deflector to a streamer, or two streamers to each other, or a streamer to a vessel, and the second through passage is configured to receive a rope that connects to an adjacent diving fairing.

8. The diving fairing of claim 1, wherein one of the first or second through passage is configured to receive an element of a front-end rigging system that connects the deflector to a streamer, or two streamers to each other, or a streamer to a vessel, and the second through passage is configured to receive a rope that connects to an adjacent diving fairing, and
the rope that connects to the adjacent diving fairing has a density different than water.

9. A set of M diving fairings to be attached to a first line of a seismic survey system, the set of M diving fairings comprising:
a sub-set of N diving fairings that are linked to each other by a second line so that the N diving fairings maintain substantially the same angle of attack when towed in water; and
a sub-set of M-N diving fairings that are linked to each other only by the first line so that the M-N diving fairings have independent angles of attack,
where M is an integer and N is an integer between 2 and M.

10. The set of M diving fairings of claim 9, wherein N is equal to M.

11. The set of M diving fairings of claim 9, wherein the first line is a spur line.

12. The set of M diving fairings of claim 9, wherein the first line is a separation line.

13. The set of M diving fairings of claim 9, wherein the line for M1 diving fairings is a spur line and the line for M2 diving fairings is a separation line, wherein M1+M2=M, and at least two of the M1 diving fairings or the M2 diving fairings are linked to each other.

14. The set of M diving fairings of claim 9, wherein a diving fairing comprises:
a body extending along a longitudinal axis X;
a first through passage formed along a transversal axis Y, which is perpendicular on the longitudinal axis X, the first through passage configured to receive the first line; and
a second through passage formed along the transversal axis Y, offset from the first through passage, the second through passage being configured to receive the second line.

15. The set of M diving fairings of claim 14, wherein the body is symmetrical relative to the longitudinal axis X and wherein a line extending through the diving fairing has a density different than water and makes the diving fairings making a common angle of attack

16. The set of M diving fairings of claim 14, wherein a weight of the body is distributed asymmetrically along the X axis to generate a torque that makes a leading edge to move deeper in water than a trailing edge to create a non-zero angle of attack of the body with a horizontal direction.

17. A seismic survey system comprising:
a deflector;
a streamer having seismic receivers for recording seismic waves;
a first line that connects the deflector to the streamer;
first and second diving fairings attached to the first line; and
a second line to connect the first diving fairing to the second diving fairing, wherein the second line has a density different than water.

18. The system of claim 17, wherein the deflector pulls the first line and the streamer laterally but also upward, with regard to gravity, while recording seismic data, and the first and second diving fairings pull the first line and the streamer downward, along the gravity direction, to counter-balance the pull of the deflector.

19. The system of claim 17, further comprising:
an anti-drag fairing attached to the first line,
wherein the anti-drag fairing only reduces a drag of the first line when towed in water, but is not configured to pull the fairing upward or downward.

20. The system of claim 17, wherein one of the first or second line has a density different than water.
